(19) United States
(12) Patent Application Publication
(10) Pub. No.: US 2003/0233293 A1
(43) Pub. Date: Dec. 18, 2003

(54) Warehouse management system and method

(76) Inventors: Michael Hsu, Shenzhen (CN); Yarchen Wen, Shenzhen (CN); ZhiGang He, Shenzhen (CN); Simon Shen, Shenzhen (CN); Taylor Liu, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/193,380

(22) Filed: Jul. 10, 2002

(30) Foreign Application Priority Data
Jun. 13, 2002 (TW) 91112872

(51) Int. Cl. G06F 17/60

(52) U.S. Cl. 705/28

(57) ABSTRACT

A system and method for putting in-warehouse articles in a correct location in a warehouse (9), and for quickly retrieving out-warehouse articles from the warehouse. The system includes: a central management server (1) that includes a database (10) for storing in-warehouse article data, inventory data, out-warehouse article data and storage location information; a plurality of computing devices (3) located in different warehouses and linking to the central management server via an intranet (2); and a plurality of barcode printers (4) respectively linking to the plurality of computing devices for printing inventory data barcodes (14) that are attached to pallets (12). Each computing device comprises: an in-warehouse module (30) for querying location information in the database, selecting locations for storing pallets loaded with articles, and storing in-warehouse article data in the database; and an out-warehouse module (34) for selecting pallets loaded with first-in articles and generating a selection list (15).

### BACKGROUND OF THE INVENTION

1. Field of the Invention

The present invention relates to warehouse management systems and methods, and particularly to a system and method for controlling receipt and distribution of articles in a warehouse.

2. Background of the Invention

For a manufacturing enterprise, inventory costs are generally a significant component of total operating costs. Controlling and lowering inventory costs is key to lowering total costs and increasing profits of a manufacturing enterprise.

One way to lower inventory costs is to efficiently manage inventory in a warehouse, especially upon receipt and distribution of articles in the warehouse. A warehouse managing system is disclosed in U.S. Pat. No. 6,026,378. In the warehouse managing system, upon receipt of an article, an article code for the article and a location code for a shelf storing the article are stored as management data. When the management data are stored, a manufacturing date and a number of a pallet for moving the article are also stored. A host computer can use such data to provide first-in and first-out warehouse management.

However, the warehouse managing system merely reduces use of paper such as article information slips and article order forms. Receiving and storing an article in the right place in a warehouse is still problematic. Similarly, distributing the article from the warehouse quickly and efficiently is also still problematic.

### SUMMARY OF THE INVENTION

Accordingly, it is a general object of the present invention is to provide a warehouse management system for putting in-warehouse articles in a correct location in a warehouse, and for quickly retrieving out-warehouse articles from the warehouse.

Another general object of the present invention is to provide a warehouse management method for putting in-warehouse articles in a correct location in a warehouse, and for quickly retrieving out-warehouse articles from the warehouse.

In order to accomplish the above-mentioned objects, the present invention provides a central warehouse management system and method for putting in-warehouse articles in a correct location in a warehouse, and for quickly retrieving out-warehouse articles from the warehouse. A preferred embodiment of the system comprises: a central management server that comprises a database for storing in-warehouse article data, inventory data, out-warehouse article data and storage location information; a plurality of computing devices located in different warehouses and linking to the central management server via an intranet; and a plurality of barcode printers respectively linking to the plurality of computing devices for printing inventory data barcodes that are attached to pallets. Each computing device comprises: an in-warehouse module for querying location information in the database, selecting locations for storing pallets loaded with articles, and storing in-warehouse article data in the database; and an out-warehouse module for selecting pallets loaded with first-in articles and generating a selection list.

A preferred embodiment of the method comprises the steps of: (i) querying a database for information on a location for storing a pallet loaded with an in-warehouse article, according to a flag of the in-warehouse article; (ii) selecting a location for storing the in-warehouse article and assigning a pallet number, according to the location information obtained; (iii) generating inventory data according to the location information obtained and pallet number, and transmitting the inventory data to a central management server, the central management server storing the inventory data in the database; (iv) printing a barcode that comprises inventory data on the pallet, and pasting the barcode on the pallet; (v) querying inventory data in the database according to a flag of an out-warehouse article, and obtaining an inventory data list of all pallets loaded with the out-warehouse article; (vi) generating a selection list according to the inventory data list; and (vii) generating out-warehouse article data according to the selection list.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of infrastructure of a warehouse management system in accordance with a preferred embodiment of the present invention;

FIG. 2 is a schematic diagram of a pallet in accordance with the preferred embodiment of the present invention;

FIG. 3 schematically illustrates functional infrastructure of a computing device in accordance with the preferred embodiment of the present invention;

FIG. 4 is a schematic diagram of data flow between the computing device and a database in accordance with a preferred embodiment of the present invention;

FIG. 5 schematically illustrates functional infrastructure of a website server, in accordance with the preferred embodiment of the present invention;

FIG. 6 is a flowchart of tasks related to receiving articles, in accordance with the preferred embodiment of the present invention; and

FIG. 7 is a flowchart of tasks related to distributing articles, in accordance with the preferred embodiment of the present invention.

### DETAILED DESCRIPTION OF PREFERRED EMBODIMENTS OF THE INVENTION

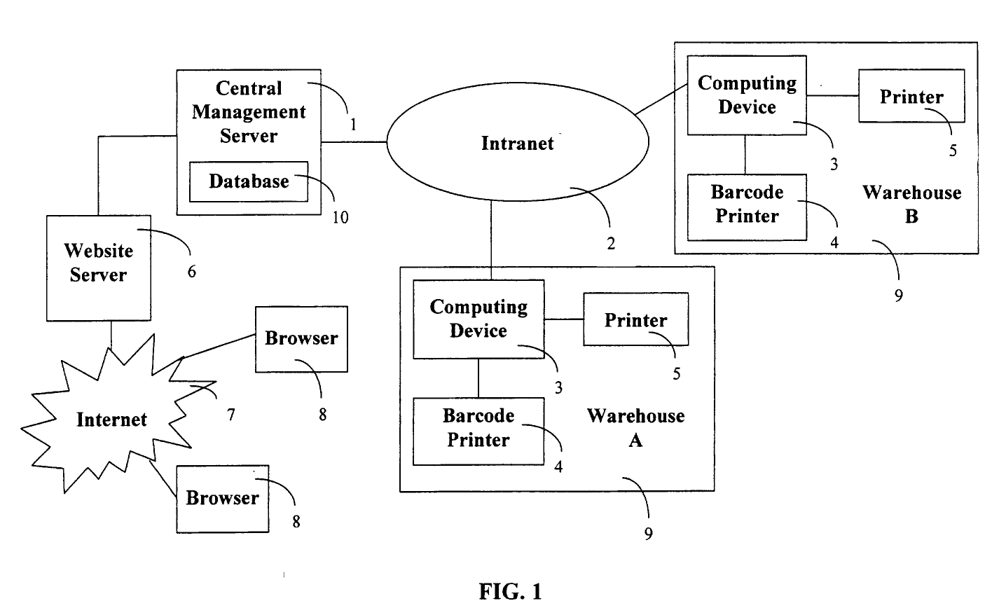

FIG. 1 is a schematic diagram of infrastructure of a warehouse management system in accordance with a preferred embodiment of the present invention. The warehouse management system comprises a central management server 1, a website server 6, and plurality of computing devices 3. The central management server 1 comprises a database 10 that stores data such as in-warehouse article data, inventory data, out-warehouse article data, information on articles, information on customers and information on locations. The in-warehouse article data comprise article names, article codes, warehouse codes, location numbers, pallet numbers, article quantities, receiving dates, and operator codes. The inventory data comprise warehouse codes, location numbers, pallet numbers, article names, article quantities, manufacturing dates, receipt dates and vendors. The information on locations comprises warehouse codes, location numbers, available quantities of pallets to be stored, quantities of pallets already stored, and names of stored articles.

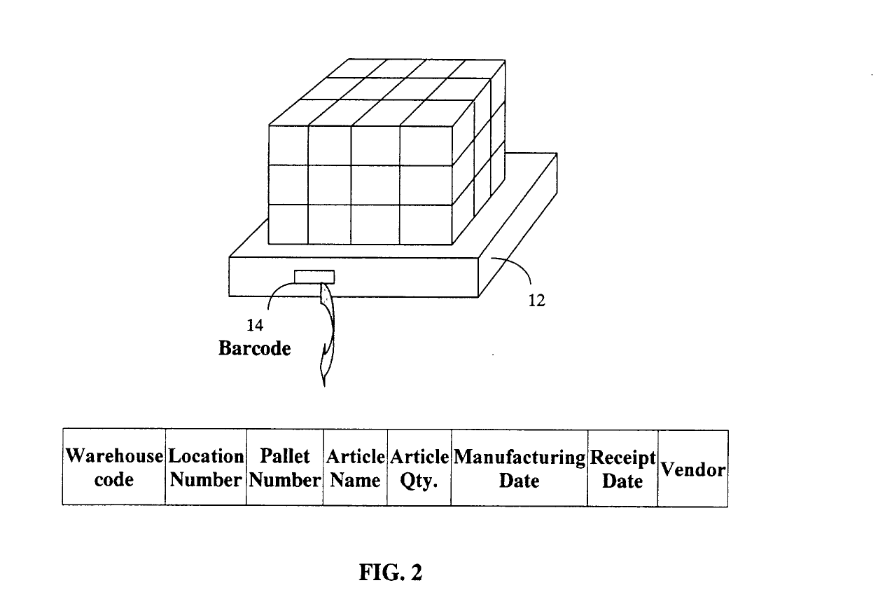

Each computing device 3 is placed in a respective one of a plurality of warehouses 9, and is linked to the central management server 1 via an intranet 2. The computing device 3 can assist querying of in-warehouse article information, inventory data and out-warehouse article information. In the preferred embodiment of the present invention, each computing device 3 is linked with a respective barcode printer 4. Referring also to FIG. 2, the barcode printer 4 generates barcodes 14. Each barcode 14 comprises inventory data on a pallet 12, and is pasted on the pallet 12. Each computing device 3 is also linked with a respective conventional printer 5.

The website server 6 is linked to the central management server 1. Users can respectively use a plurality of browsers 8 to access the website server 6 via the Internet 7. In the present invention, a preferred browser 8 is Internet Explorer (IE) 5.0 by Microsoft, or Navigator 5.0 by Netscape. Users include not only operators in a warehouse, but also customers and vendors. Each user has a unique authority to access the website 6. When accessing the website 6, the users can obtain information comprising in-warehouse article data, inventory data, out-warehouse article data, information on articles, and information on customers.

FIG. 2 is a schematic diagram of one pallet 12. In the preferred embodiment, each warehouse comprises a plurality of locations. Each location stores a plurality of pallets 12. In-warehouse articles are loaded on the pallets 12. The barcode 14 pasted on each pallet 12 comprises information on warehouse code, location number, pallet number, article name, article quantity, manufacturing date, receipt date and vendor.

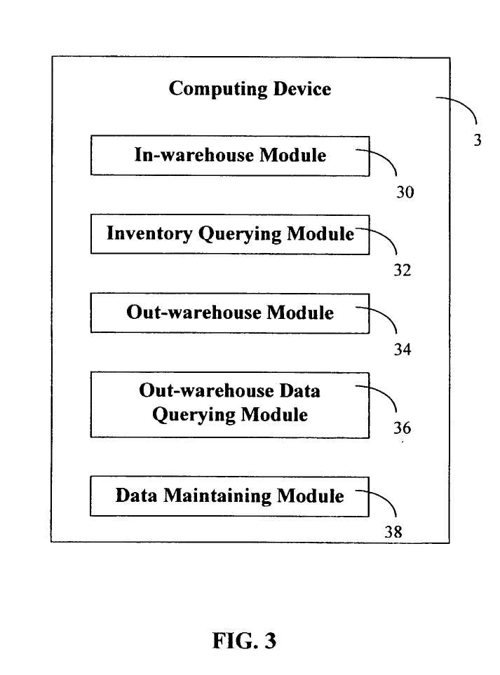

FIG. 3 schematically illustrates functional infrastructure of each computing device 3. The computing device 3 comprises an in-warehouse module 30, an inventory querying module 32, an out-warehouse module 34, an out-warehouse data querying module 36, and a data maintaining module 38. The in-warehouse module 30 can assist an operator to receive in-warehouse articles in a warehouse, and to generate barcodes 14 to be pasted on pallets 12 loaded with in-warehouse articles. The inventory querying module 32 provides querying of inventory data stored in the database 10 according to location, receipt date, vendor or article name. The out-warehouse module 34 is used for assisting distribution of articles from warehouses. This includes tasks such as selecting articles, selecting a mode of shipment, selecting a forwarder, and generating out-warehouse article data. The out-warehouse data querying module 36 provides querying of out-warehouse article data according to article name, location, date of out-warehousing, vendor or customer. The data maintaining module 38 is used for defining, setting, adding, modifying, and deleting data in the database 10. Such data comprise information on vendors, customers, locations and articles.

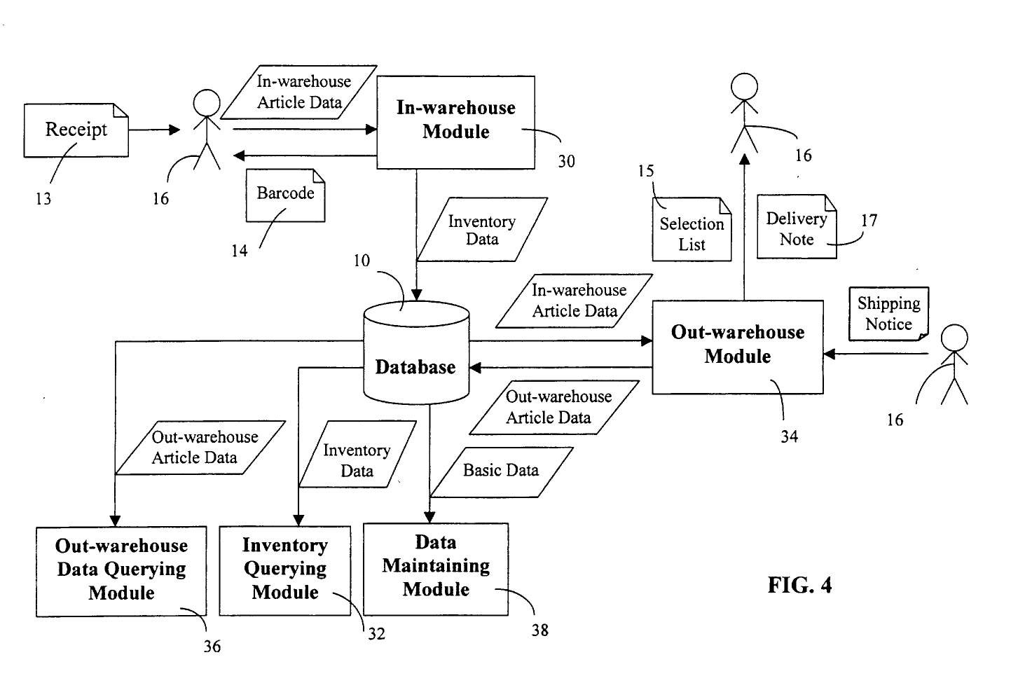

FIG. 4 is a schematic diagram of data flow between one computing device 3 and the database 10, in accordance with a preferred embodiment of the present invention. An operator 16 receives a receipt 13. The operator 16 logs on the in-warehouse module 30 in the computing device 3, and inputs in-warehouse article data according to the receipt 13. The in-warehouse module 30 stores the in-warehouse article data in the database 10 as inventory data, and generates barcodes 14 comprising information on the in-warehouse article data. When articles in a warehouse need to be distributed, the operator 16 logs on the out-warehouse module 34. The operator 16 inputs information on a shipping notice, such as name and quantity of the articles to be distributed. The out-warehouse module 34 queries the database 10 according to the name of the articles to be distributed, to obtain inventory information on the articles to be distributed. The operator 16 selects pallets 12 loaded with the articles to be distributed, a forwarder, and a mode of shipment. The operator 16 then generates a selection list 15 and a delivery note 17 according to the inventory information. After the articles have been distributed, the out-warehouse module 34 stores out-warehouse article data in the database 10. Relevant operators 16 can: access out-warehouse article data in the database 10 by using the out-warehouse data querying module 36; access the database 10 for inventory data by using the inventory querying module 32; and/or maintain data on vendors, customers, locations and articles in the database 10 by using the data maintaining module 38.

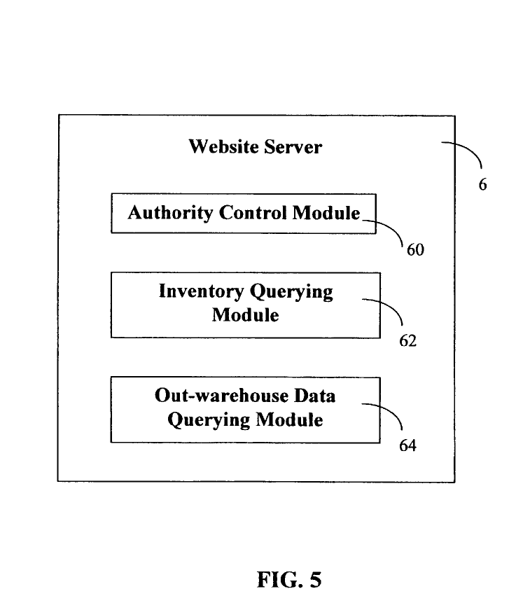

FIG. 5 schematically illustrates functional infrastructure of the website server 6, in accordance with the preferred embodiment of the present invention. The website server 6 comprises an authority control module 60, an inventory querying module 62, and an out-warehouse data querying module 64. The authority control module 60 is used for managing authorities of different users such as operators, customers and vendors. The inventory querying module 62 provides querying of inventory data according to location, receiving date, vendor or article name. The out-warehouse data querying module 64 provides querying of out-warehouse article data according to article name, location, out-warehouse date, vendor, or customer.

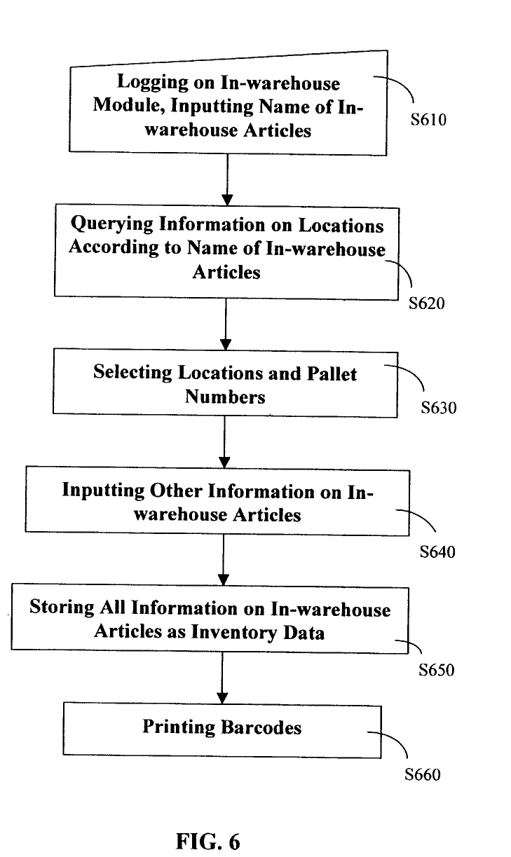

FIG. 6 is a flowchart of tasks related to receiving articles, in accordance with the preferred embodiment of the present invention. When articles are received at a warehouse, an operator 16 in that warehouse logs on the in-warehouse module 30 of the computing device 3 in that warehouse. The operator 16 inputs a name of the in-warehouse articles via a graphic user interface (GUI) of the computing device 3 (step S610). The name of the in-warehouse articles may, for example, be ‘CPU’ (central processing unit). The in-warehouse module 30 queries information on locations in the database 10 according to a flag of the in-warehouse articles (step S620). In the preferred embodiment of the present invention, the flag is the name of the in-warehouse articles. For example, the flag is ‘CPU.’ If information on a location indicates that the location is used for storing CPUs, and the location can store at least one pallet 12 loaded with in-warehouse articles named CPU, the in-warehouse module 30 treats the location as an available location for storing the in-warehouse articles named CPU. If there are two or more locations available for storing CPUs, the in-warehouse module 30 arranges the locations in descending order according to capacity available for storing pallets 12 loaded with CPUs. The operator 16 selects locations for storing the pallets 12 loaded with CPUs, and sets serial numbers for numbering the pallets 12 (step S630). The serial numbers are assigned in chronological order. For example, if a most recent serial number assigned for a pallet 12 is 00072, then the operator 16 sets a current serial number as 00073. The operator 16 then inputs other information on the in-warehouse articles, such as quantity, manufacturing date and vendor (step S640). The computing device 3 transmits all the above-mentioned input invention to the central management server 1. The central management server 1 stores all the input information in the database 10 as inventory data (step S650). The barcode printer 4 generates and prints barcodes 14 according to the input information (step S660). Each barcode 14 contains information comprising warehouse code, location number, pallet number, article name, article quantity, manufacturing date and vendor.

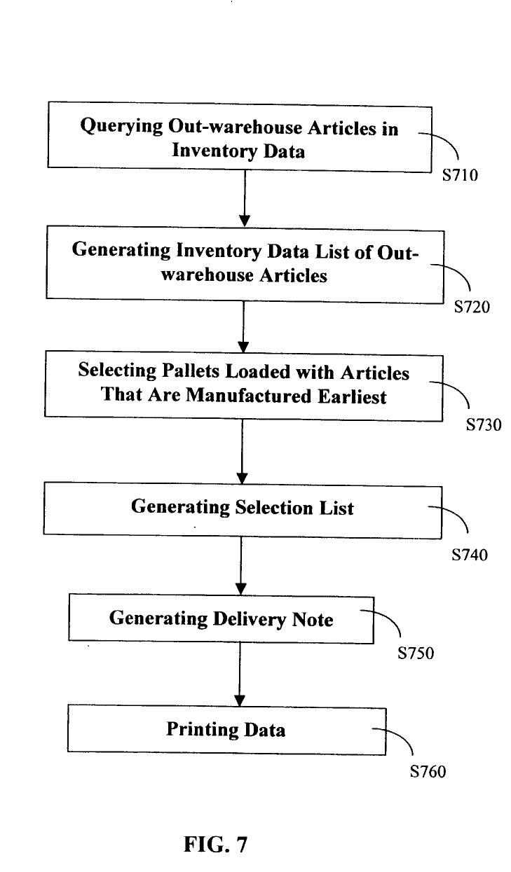

FIG. 7 is a flowchart of tasks related to distributing articles, in accordance with the preferred embodiment of the present invention. An operator 16 receives a shipping notice, and the operator 16 logs on the out-warehouse module 34 of the computing device 3 in a warehouse. The operator 16 queries inventory data in the database 10 according to a flag of out-warehouse articles listed in the shipping notice (step S710). In the preferred embodiment of the present invention, the flag of the out-warehouse articles is a name of the out-warehouse articles. After obtaining the inventory data on the out-warehouse articles, the computing device 3 generates an inventory data list of each pallet 12 loaded with the out-warehouse articles. The inventory data list is arranged in chronological order of manufacturing dates of the out-warehouse articles (step S720).

The computing device 3 selects pallets 12 loaded with the articles that are manufactured earliest, according to the inventory data list (step S730). The computing device 3 then generates the selection list 15, which comprises warehouse code, location number, number of pallets 12 loaded with the articles, name of the articles, inventory quantity of the articles, manufacturing date, receipt date and vendor of the articles (step S740). The operator 16 can efficiently retrieve the out-warehouse articles from the warehouse according to the selection list 15. The operator 16 then inputs information on a forwarder and a mode of shipment to the computing device 3. The computing device 3 generates the delivery note 17 according to the selection list 15 and the information on the forwarder and the mode of shipment (step S750). The delivery note 17 comprises warehouse code, location number, numbers of pallets 12 loaded with the out-warehouse articles, name of the articles, quantity of the articles, manufacturing date, receipt date, vendor, distribution date, customer, forwarder, and mode of shipment. After the articles are distributed, the operator 16 prints the above-mentioned data, such as the selection list 15 and the delivery note 17, by using the printer 5 (step S760).

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A central warehouse management system, comprising:
a central management server comprising a database for storing in-warehouse article data, inventory data, out-warehouse article data and storage location information;
at least one computing device in at least one warehouse, the at least one computing device linking to the central management server via an intranet, the at least one computing device comprising:
an in-warehouse module for querying location information in the database, selecting locations for storing pallets loaded with articles, and storing in-warehouse article data in the database;
an out-warehouse module for selecting pallets loaded with first-in articles and generating a selection list; and
at least one barcode printer linking to the at least one computing device for printing inventory data barcodes that are attachable to pallets.

2. The central warehouse management system as claimed in claim 1, further comprising a website server linking to the central management server.

3. The central warehouse management system as claimed in claim 1, further comprising a printer for printing the selection list.

4. The central warehouse management system as claimed in claim 1, wherein the selection list records inventory data that comprise warehouse code, location number, pallet number, article name, article quantity, manufacturing date, receipt date, and vendor.

5. The central warehouse management system as claimed in claim 1, wherein the location information comprises warehouse code, location number, available quantity of pallets to be stored, quantity of pallets already stored, and name of stored article.

6. The central warehouse management system as claimed in claim 1, wherein the inventory data barcodes comprise information on warehouse code, location number, pallet number, article name, article quantity, manufacturing date, receipt date, and vendor.

7. The central warehouse management system as claimed in claim 1, wherein the out-warehouse article data comprise warehouse code, location number, pallet number, article name, article quantity, manufacturing date, receipt date, vendor, distribution date, customer, forwarder, and mode of shipment.

8. The central warehouse management system as claimed in claim 1, wherein the at least one computing device further comprises an inventory querying module, an out-warehouse article data querying module, and a data maintaining module.

9. The central warehouse management system as claimed in claim 8, wherein the inventory querying module provides querying of inventory data stored in the database according to location, receipt date, vendor and/or article name.

10. The central warehouse management system as claimed in claim 8, wherein the out-warehouse article data querying module provides for querying of out-warehouse articles according to article name, location, date of out-warehousing, vendor and/or customer.

11. The central warehouse management system as claimed in claim 8, wherein the data maintaining module is used for defining, setting, adding, modifying, and/or deleting data in the database.

12. The central warehouse management system as claimed in claim 11, wherein the data in the database comprise vendor information, customer information, location information and article information.

13. A central warehouse management method for receiving an article, the method comprising the steps of:
(a) querying a database for information on a location for storing a pallet loaded with an in-warehouse article, according to a flag of the in-warehouse article;
(b) selecting a location for storing the in-warehouse article and assigning a pallet number, according to the location information obtained;
(c) generating inventory data according to the location information obtained and pallet number, and transmitting the inventory data to a central management server, the central management server storing the inventory data in the database; and
(d) printing a barcode that comprises inventory data on the pallet, and attaching the barcode to the pallet.

14. The central warehouse management method as claimed in claim 13, further comprising the following steps for distributing an article:
(e) querying inventory data in the database according to a flag of an out-warehouse article, and obtaining an inventory data list of all pallets loaded with the out-warehouse article;
(f) generating a selection list according to the inventory data list; and
(g) generating out-warehouse article data according to the selection list.

15. The central warehouse management method as claimed in claim 13, wherein the flag of the in-warehouse article is a name of the in-warehouse article, and the flag of the out-warehouse article is a name of the out-warehouse article.

16. The central warehouse management method as claimed in claim 13, wherein an available quantity of pallets to be loaded with the in-warehouse article is more than zero.

17. The central warehouse management method as claimed in claim 13, wherein the location information is arranged in descending order according to capacity available for storing pallets.

18. The central warehouse management method as claimed in claim 13, wherein the inventory data generated in step (c) comprises quantity of the in-warehouse article, manufacturing date, and vendor thereof.

19. The central warehouse management method as claimed in claim 14, wherein the selection list generated in step (f) comprises warehouse code, location number, pallet number, article name, article quantity, manufacturing date, receipt date, and vendor.

20. The central warehouse management method as claimed in claim 14, wherein the inventory data list obtained in step (e) is arranged in chronological order of manufacturing dates of the out-warehouse article.

21. A process for controlling distribution of articles out of a warehousing, comprising:
(a) querying inventory data in the database according to a flag of an out-warehouse article, and obtaining an inventory data list of all pallets loaded with the out-warehouse article;
(b) generating a selection list of said pallets according to the inventory data list under a first-in first-out principle; and
(c) generating out-warehouse article data according to the selection list.
